(19) United States
(12) Patent Application Publication
(10) Pub. No.: US 2007/0265838 A1
(43) Pub. Date: Nov. 15, 2007

(54) Voice Messaging Systems

(76) Inventors: Prem Chopra, Signal Mountain, TN (US); Janet Chopra, Signal Mountain, TN (US); Oscar Martinez, Hixson, TN (US); Ahmad K. Yasin, Chattanooga, TN (US)

Correspondence Address: STONEMAN LAW OFFICES, LTD, 3113 NORTH 3RD STREET, PHOENIX, AZ, 85012, US

(21) Appl. No.: 11/747,776

(22) Filed: May 11, 2007

Related U.S. Application Data
(60) Provisional application No. 60/747,111, filed on May 12, 2006.
(60) Provisional application No. 60/833,936, filed on Jul. 28, 2006.

(51) Int. Cl. G10L 19/00

(52) U.S. Cl. 704/201

(57) ABSTRACT

A voice messaging system sends a notification to a receiving unit that a message has been recorded and immediate attention is required for the proper person to listen to the message. Upon listening to the message a return notification may be sent to the unit from which the message originated to alert the sender that the message has been heard, and optionally that the listener has a return message. Additionally, the voice messaging system can provide patient status information (e.g., condition, course of treatment) telephonically in a confidential manner to a loved one. The system can also provide after-care information to a patient after hospital discharge.

### CROSS-REFERENCE TO RELATED APPLICATIONS

The present application is related to and claims priority from prior provisional applications Ser. No. 60/747,111, filed May 12, 2006, and 60/833,936, filed Jul. 28, 2006, both entitled “VOICE MESSAGING SYSTEMS”, the contents of both of which are incorporated herein by this reference and are not admitted to be prior art with respect to the present invention by the mention in this cross-reference section.

### BACKGROUND

This invention relates to providing a system for facilitating communication. More particularly this invention relates to providing a phone messaging system for confidentially recording, transmitting, and receiving important messages.

Typically, patient reports are communicated orally from one person, such as a nurse, to another person, such as a doctor. Every time such information needs to be communicated, such as during a shift change or patient transfer, the two people involved usually must arrange a time when they can meet face to face to facilitate oral communication. Since doctors and nurses are very busy, when one person is available the other person is often not available, making the communication of reports problematic. Moreover, it is also often necessary for hospitals to communicate to family members patient condition, course of treatment, expected outcomes, etc. Also, after discharge, the hospital often must communicate after-care information.

Accordingly, a great need exists for improved communication techniques for confidentially recording, transmitting, and receiving important messages.

### OBJECTS AND FEATURES OF THE INVENTION

A primary object and feature of the present invention is to provide a system for recording voice messages using telephone systems.

It is a further object and feature of the present invention to provide such a system which sends a notification to a receiving unit that a message has been recorded and immediate attention is required for the proper person to listen to the message. It is a further object and feature of the present invention to provide such a system which sends a return notification to the sending unit to alert the message sender that the message has been heard, that the listener has questions, or that the message has not yet been received.

It is a further object and feature of the present invention to provide such a system which can communicate the existence of a report by telephone, pager (numerical or text), email, fax and/or other display applications (such as, for example, a web site). It is a further object and feature of the present invention to provide such a system which can transmit a message to multiple users and by multiple means of communication simultaneously. It is a further object and feature of the present invention to provide such a system which can similarly transmit a reply that the message was transmitted. It is a further object and feature of the present invention to provide such a system which can automatically forward notifications by re-routing them as needed to the appropriate destination (such as, for example, when a patient transferred from one location to another).

It is a further object and feature of the present invention to provide such a system which allows a user to broadcast bulletins to a plurality of users. It is a further object and feature of the present invention to provide such a system which permits patients and authorized family members to access reports. It is a further object and feature of the present invention to provide such a system which allows a discharged patient to receive after-care information and instructions. It is a further object and feature of the present invention to provide such a system which allows a user to generate hospital bed-readiness status reports. It is a further object and feature of the present invention to provide such a system which can be accessed and managed via a visual computer interface.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a computer-based messaging system, relating to managing audio message communication between at least one first user and at least one second user of at least one plurality of users comprising the steps of: permitting, by such at least one first user, recording at least one first audio message; storing such at least one first audio message in at least one audio messaging database; sending, to such at least one second user, at least one first notification that such at least one first audio message has been recorded; permitting such at least one second user to play back such stored at least one first audio message; and sending, to such at least one first user, at least one second notification that such stored at least one first audio message has been played back.

Moreover, it provides such a computer-based messaging system further comprising the steps of: permitting such at least one second user to record at least one second audio message; storing such at least one second audio message in such at least one audio messaging database; wherein such at least one second notification comprises at least one indication that such at least one second audio message has been recorded; and permitting such at least one first user to play back such stored at least one second audio message. Additionally, it provides such a computer-based messaging system further comprising the step of permitting such at least one second user to optionally delay sending such at least one second notification. Also, it provides such a computer-based messaging system wherein such at least one second notification message comprises information identifying such at least one second user. In addition, it provides such a computer-based messaging system further comprising the step of permitting such at least one first user to optionally delay sending such at least one first notification. And, it provides such a computer-based messaging system comprising the steps of: permitting capture of at least one name relating to at least one patient; storing such at least one name relating to such at least one patient in at least one audio messaging database; permitting capture of at least one medical history relating to such at least one patient; storing such at least one medical history relating to such at least one first patient in at least one audio messaging database; permitting capture of at least one medical report relating to such at least one patient; and storing such at least one medical report relating to such at least one patient in at least one audio messaging database.

Further, it provides such a computer-based messaging system comprising the steps of permitting capture of at least one care reminder which can be accessed by such at least one patient. Even further, it provides such a computer-based messaging system comprising the step of allowing such at least one first user to insert at least one pre-recorded header associated with at least one section of such at least one medical report. Moreover, it provides such a computer-based messaging system comprising the step of permitting such at least one first user to create at least one report template to facilitate inserting at least one pre-recorded header into such at least one medical report.

Additionally, it provides such a computer-based messaging system comprising the steps of: permitting such at least one first user to create at least one survey; storing such at least one survey; and permitting such at least one second user to respond to such stored at least one survey. Also, it provides such a computer-based messaging system wherein such at least one first audio message is recorded using at least one telephone. In addition, it provides such a computer-based messaging system wherein such at least one first notification is sent via at least one pager. And, it provides such a computer-based messaging system wherein such at least one first notification is sent via at least one fax machine. Further, it provides such a computer-based messaging system wherein such at least one first notification is sent via at least one telephone.

Even further, it provides such a computer-based messaging system wherein such at least one first notification is sent via at least one workstation computer. Moreover, it provides such a computer-based messaging system wherein such at least one first notification is presented on at least one browser-based display using such at least one workstation computer. Additionally, it provides such a computer-based messaging system comprising the steps of: obtaining at least one bed inventory comprising at least one plurality of beds; storing such at least one bed inventory in such at least one audio messaging database; and associating at least one first bed of such plurality of beds with such at least one patient. Also, it provides such a computer-based messaging system comprising the steps of: permitting recording at least one transfer of such at least one patient from such at least one first bed to at least one second bed; storing such at least one transfer of such at least one patient from such at least one first bed to at least one second bed in such at least one audio messaging database; and permitting, by such at least one first user, querying such at least one audio messaging database, using such at least one first bed, to determine such at least one second bed relating to such at least one transfer relating to such at least one patient.

In addition, it provides such a computer-based messaging system wherein such at least one first audio message comprises such at least one transfer of such at least one patient from such at least one first bed to such at least one second bed. And, it provides such a computer-based messaging system comprising the step of generating at least one bed status report from such at least one bed inventory. Further, it provides such a computer-based messaging system wherein such at least one bed status report comprises at least one bed occupation status. Even further, it provides such a computer-based messaging system comprising the steps of: permitting recording at least one family message relating to such at least one patient by such at least one first user; storing such at least one family message relating to such at least one patient in such at least one audio messaging database; and permitting at least one family member of such at least one patient to play back such at least one family message relating to such at least one patient.

Even further, it provides such a computer-based messaging system comprising the steps of: permitting capture of at least one admission report relating to at least one patient from at least one admitting physician; storing such at least one admission report relating to at least one patient in such at least one audio messaging database; permitting such at least one first user to record at least one medical alert relating to such at least one patient; and storing such at least one medical alert relating to such at least one first patient in such at least one audio messaging database; wherein such at least one medical alert must be played back during play back of such stored at least one first audio message. Even further, it provides such a computer-based messaging system comprising the steps of: permitting such at least one first user to create at least one group message; and wherein such at least one group message will be delivered to at least one set of such users of such at least one plurality of user, and wherein such at least one group message may be created from such at least one first message; requiring, by each such user of such at least one set of such users, play back of such at least one group message. Even further, it provides such a computer-based messaging system comprising the steps of: permitting such at least one first user to access such at least one audio messaging database using at least one visual computer display. Even further, it provides such a computer-based messaging system comprising the steps of: permitting such at least one first user to visually display at least one report retrieved from such at least one audio messaging database using at least one visual computer display.

Even further, it provides such a computer-based messaging system comprising the steps of: permitting such at least one first user to send at least one bulletin message to at least one plurality of recipients using at least one visual computer interface. In accordance with another preferred embodiment hereof, this invention provides a computer-based method, relating to providing audio-based electronic messaging between at least one first user and at least one second user, comprising the steps of: offering at least one voice messaging product to at least one hospital; licensing such at least one voice messaging product to such at least one hospital; assisting implementation of such at least one voice messaging product to such at least one hospital; providing access to such at least one hospital of at least one voice message database; and receiving payment from such at least one hospital.

Additionally, it provides a telephonic method for managing patient after-care, comprising the steps of: recording at least one audio message, the at least one audio message including information related to patient after-care; receiving, via a telephone, at least one request to play such at least one audio message; validating the at least one request, to establish that the at least one request is from a discharged patient authorized to receive the at least one audio message; and playing the at least one audio message, via the telephone, only if the at least one request is validated.

Even further, it provides a telephonic method for providing patient status information, comprising the steps of: recording at least one audio message, the at least one audio message including information related to the status of a patient; receiving, via a telephone, at least one request to play such at least one audio message; validating the at least one request, to establish that the at least one request is from a person eligible to receive confidential health-related information about the patient; and playing the at least one audio message, via the telephone, only if the at least one request is validated.

### BRIEF DESCRIPTION OF THE DRAWINGS

FIG. 1 shows a simplified diagram of a voice messaging system according to a preferred embodiment of the present invention.

FIG. 2 shows a simplified diagram of the automatic voice messaging notification and receipt method according to a preferred embodiment of the present invention.

FIG. 3 shows a simplified diagram of a voice messaging system business method according to a preferred embodiment of the present invention.

FIG. 4 shows a voice messaging system computer interface, according to a preferred embodiment of the present invention, which facilitates user authorization.

FIG. 5 shows a voice messaging system computer interface, according to a preferred embodiment of the present invention, which displays messaging system provider contact information.

FIG. 6 shows a voice messaging system computer interface, according to a preferred embodiment of the present invention, which facilitates sending bulletins to a plurality of users.

FIG. 7 shows a voice messaging system computer interface, according to a preferred embodiment of the present invention, which facilitates managing lists of recipients for bulletins.

FIG. 8 shows a voice messaging system computer interface, according to a preferred embodiment of the present invention, which facilitates sorting and filtering users to create and edit distribution lists of users.

FIG. 9 shows a voice messaging system computer interface, according to a preferred embodiment of the present invention, which facilitates managing bed status at hospitals.

FIG. 10 shows a voice messaging system computer interface, according to a preferred embodiment of the present invention, which facilitates managing bed status at hospitals.

FIG. 11 shows a sample instruction card provided to patients upon discharge, according to a preferred embodiment of the present invention.

### DETAILED DESCRIPTION OF THE BEST MODES AND PREFERRED EMBODIMENTS OF THE INVENTION

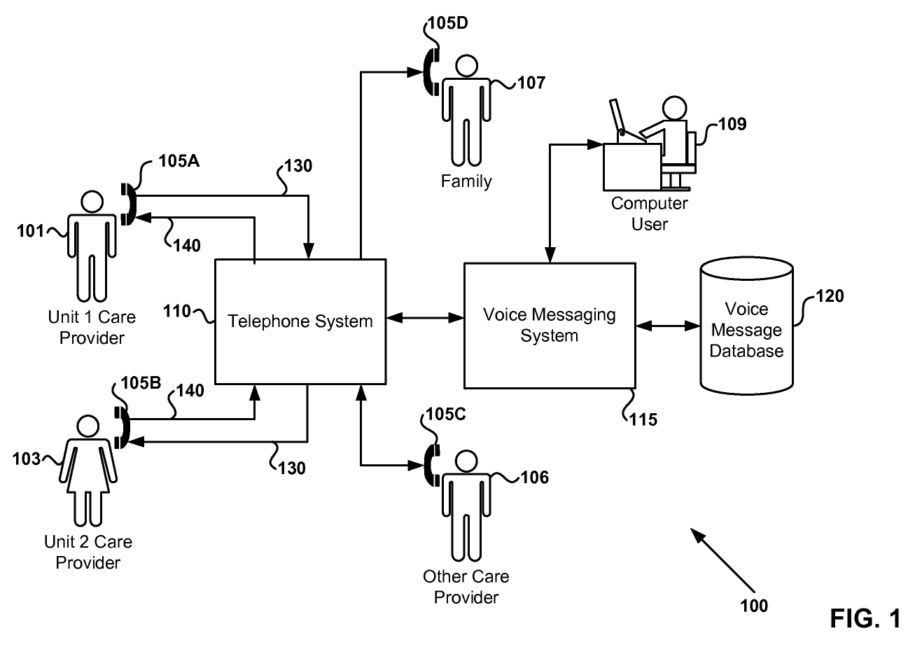

FIG. 1 shows a simplified diagram of a voice messaging system 100 according to a preferred embodiment of the present invention.

Preferably, user 101, (such as, for example, a Care Provider in Unit 1 of a hospital) uses telephone 105A to access telephone system 110, as shown. Preferably, user 101 accesses voice messaging system 115 via telephone system 110 and records message 130 (at least embodying herein permitting, by such at least one first user, recording at least one first audio message; and at least embodying herein wherein such at least one first audio message is recorded using at least one telephone), which is stored in voice message database 120 (at least embodying herein storing such at least one first audio message in at least one audio messaging database), as shown. Preferably, voice messaging system 115 provides limited access to authorized users. Preferably voice messaging system 115 comprises menu driven navigation utilizing the telephone keypad for navigation input by user 101. Preferably, notification is sent to user 103 (such as, for example, a Care Provider in Unit 2 of a hospital) that a message has been recorded (at least embodying herein sending, to such at least one second user, at least one first notification that such at least one first audio message has been recorded). Preferably, user 103 uses telephone 105B to access telephone system 110, as shown. Preferably, user 103 accesses voice messaging system 115 via telephone system 110 and retrieves message 130 from storage in voice message database 120, as shown (at least embodying herein permitting such at least one second user to play back such stored at least one first audio message). Preferably, upon listening to the voice message 130, voice messaging system 115 presents the option to user 103 of delivering a return message 140 to user 101. Preferably, voice messaging system 115 presents the option to user 103 of immediately sending a return notification (at least embodying herein sending, to such at least one first user, at least one second notification that such stored at least one first audio message has been played back), delaying sending a return notification, or sending a return notification with a return voice message (at least embodying herein wherein such at least one second notification comprises at least one indication that such at least one second audio message has been recorded), such as, for example, including questions regarding the initial message (at least embodying herein permitting such at least one second user to record at least one second audio message). Preferably, user 101 accesses voice messaging system 115 via telephone system 110 and retrieves return message 140 from storage in voice message database 120, as shown. Preferably, user 106 (such as, for example, a pharmacist, radiologist, dietician, etc.), uses telephone 105C to access voice messaging system 115 via telephone system 110 and messages from storage in voice message database 120, as shown. Preferably, user 107 (such as, for example, a family member of a patient), uses telephone 105D to access voice messaging system 115 via telephone system 110 and messages from storage in voice message database 120, as shown. Preferably, user 109 (such as, for example, care-provider, patient, patient family member, etc.), can access voice messaging system 115 to retrieve data, and messages, such as a family message, from storage in voice message database 120 via computer network, as shown (at least embodying herein permitting recording at least one family message relating to such at least one patient by such at least one first user; and at least embodying herein storing such at least one family message relating to such at least one patient in such at least one audio messaging database; and at least embodying herein permitting at least one family member of such at least one patient to play back such at least one family message relating to such at least one patient).

Preferably, notification is sent via telephone (at least embodying herein wherein such at least one first notification is sent via at least one telephone), as shown. Upon reading the teachings of this specification, those with ordinary skill in the art will now understand that, under appropriate circumstances, considering such issues as efficiency, integration of communications technology, user preference, advances in technology, etc., other notification arrangements, such as, for example, pager (at least embodying herein wherein such at least one first notification is sent via at least one pager), email, fax (at least embodying herein wherein such at least one first notification is sent via at least one fax machine), computer network (at least embodying herein wherein such at least one first notification is sent via at least one workstation computer; and at least embodying herein wherein such at least one first notification is presented on at least one browser-based display using such at least one workstation computer), etc., may suffice. Also, upon reading the teachings of this specification, those with ordinary skill in the art will now understand that, under appropriate circumstances, considering such issues integration of communications technology, intended use, user preference, etc., other user arrangements, such as, for example, users other than care providers in different units, doctors, consultants, patients, pharmacists, insurance companies, non-medical related businesses, engineers, attorneys, etc., may suffice.

Preferably, voice messaging system 115 can be used in the field of medical care by permitting user 101 to store information about a patient in voice message database 120. Preferably, voice message database 120 stores information related to a patient based on the bed number to which the patient is assigned (at least embodying herein associating at least one first bed of such plurality of beds with such at least one patient). Preferably, voice message database 120 comprises at least one database with data including the status of hospital beds within the hospital inventory of hospital beds (at least embodying herein obtaining at least one bed inventory comprising at least one plurality of beds; and at least embodying herein storing such at least one bed inventory in such at least one audio messaging database). Preferably, voice messaging system 115 permits user 101 to store a patient's name (at least embodying herein permitting capture of at least one name relating to at least one patient; and at least embodying herein storing such at least one name relating to such at least one patient in at least one audio messaging database) and medical history in voice message database 120 (at least embodying herein permitting capture of at least one medical history relating to such at least one patient; and at least embodying herein storing such at least one medical history relating to such at least one first patient in at least one audio messaging database). Preferably, voice messaging system 115 permits user 101 to store periodic reports related to the patient in voice message database 120 (at least embodying herein permitting capture of at least one medical report relating to such at least one patient; and at least embodying herein storing such at least one medical report relating to such at least one patient in at least one audio messaging database).

Preferably voice messaging system 115 has an instant-rerecord feature that permits user 101, while recording, to instantly start rerecording (for example, if the user makes a mistake while recording). Preferably instant rerecording may be accomplished by the press of a single button (such as, for example, on a telephone keypad).

Preferably, voice messaging system 115 has an alert feature that permits user 101 to store at least one medical alert related to the patient in voice message database 120 (at least embodying herein permitting such at least one first user to record at least one medical alert relating to such at least one patient; and at least embodying herein storing such at least one medical alert relating to such at least one first patient in such at least one audio messaging database; and at least embodying herein wherein such at least one medical alert must be played back during play back of such stored at least one first audio message). Preferably, such medical alert must be listened to, and may not be skipped over, when user's listen to patient information stored in voice message database 120.

Preferably, voice messaging system 115 has a patient-transfer feature that permits user 101 to transfer a patient's information stored in voice message database 120 from one bed number to another bed number (at least embodying herein permitting recording at least one transfer of such at least one patient from such at least one first bed to at least one second bed; and at least embodying herein storing such at least one transfer of such at least one patient from such at least one first bed to at least one second bed in such at least one audio messaging database). Preferably, voice messaging system 115 has a feature that permits user 101 to send a notification that a transfer of records from one bed number to another bed number has been requested. Preferably, voice messaging system 115 has a feature that permits sending a return notification that such transfer voice message has been heard.

Preferably, voice messaging system 115 has a transfer-query feature that permits user 101 to query voice message database 120 concerning a vacant bed number to determine where the previous patient occupying such bed number has been transferred (at least embodying herein permitting, by such at least one first user, querying such at least one audio messaging database, using such at least one first bed, to determine such at least one second bed relating to such at least one transfer relating to such at least one patient).

Preferably, voice messaging system 115 has a password-management feature that permits user 101 to assign password protected IDs to other users that limit access to voice messaging system 115 and voice message database 120. Preferably, voice messaging system 115 has a feature that permits user 101 to query voice messaging system 115 in order obtain the available user ID numbers (such as, for example, so available IDs can be assigned to new users). Preferably, voice messaging system 115 has a feature that permits user 101 to query voice messaging system 115 in order to hear names associated with a particular user ID.

Preferably, voice messaging system 115 has a family-report feature that permits user 107 to hear reports from different staff members in sequence. Preferably, user 107 will be a family member or other person authorized to obtain confidential patient information. Preferably, a nurse, physician or other care provider records a report at regular intervals, such as, for example, once per day. Preferably, a brief description of how to use the voice messaging system 115 is initially provided to the user 107. Preferably, a designated family member receives the necessary ID, PIN number, and telephone number. Preferably, user 107 will dial the telephone number, enter the ID and PIN # and then, preferably, hear an audio message regarding medical status of their loved one. Preferably, access to the voice messaging system 115 by user 107 will be via any standard telephone or wireless telephone anywhere in the world. Preferably, at least one telephone will be installed in a facility waiting area to allow user 107 to access the voice messaging system 115 from within the facility. Preferably, the voice messaging system 115 will also allow family members to leave their own voicemail for one another. Advantageously, the family-report feature described herein provides an easier and more secure method to comply with HIPAA regulations, reduces risk that confidential information is provided to an unauthorized person, improves consistency of information provided to family members, reduces family frustration by providing them with immediate access to information regarding the loved ones, and reduces interruptions to staff from calls from multiple family members.

Preferably, voice messaging system 115 has an admission report feature that permits user 101 to capture at least one admission report from at least one admitting physician (at least embodying herein permitting capture of at least one admission report relating to at least one patient from at least one admitting physician; and at least embodying herein storing such at least one admission report relating to at least one patient in such at least one audio messaging database).

Preferably, voice messaging system 115 has a care-reminder feature (at least embodying herein permitting capture of at least one care reminder which can be accessed by such at least one patient) that permits user 101 to record a ‘care reminder’ for user 107 (such as, for example, a patient). Preferably, when a patient is discharged from the hospital, user 101 may optionally record a ‘care reminder’ for the patient. For example, care reminders can be used to communicate information about the patient's current condition, phase in episode of illness, nature of treatments/procedures, goals to be met, services needed by the patient, medications to take (the dosage, time of day, and frequency), possible side effects of prescribed medications, follow-up appointment information, home care instructions (activity level, diet, restrictions), signs of infection or worsening condition, contact information and phone numbers to call in case of emergency, etc. Preferably, hospital units can customize the prompts relevant to their units to be played during the recording session with the patient to be discharged. Preferably, user 107 accesses the patient care reminder menu of voice messaging system 115 from home to be reminded of any after care instructions. Preferably, when user 101 prepares to discharge a patient's records from voice messaging system 115, user 101 will be prompted with the option of recording a patient care reminder. Preferably, if user 101 chooses to record the care reminder, the patient's old bed number will be freed for use in voice messaging system 115 and virtual discharge of the patient's records from voice messaging system 115 will not be necessary. Preferably, the menu of options is customized so that each patient hears his or her personalized care instructions. This helps to mitigate a situation where there is a large menu that includes options not applicable to a particular patient. For example, the menu option for the patient may change with every visit or change of instruction from the care provider. Preferably, voice messaging system 115 ensures the privacy of patient information in accordance with HIPAA guidelines. By allowing patients to access care reminder information via voice messaging system 115, phone calls to the nurses' station and interruptions to hospital staff can be dramatically reduced.

Preferably, voice messaging system 115 has a survey feature that permits user 101 to create, and distribute customizable surveys to other users of voice messaging system 115 (at least embodying herein permitting such at least one first user to create at least one survey; and at least embodying herein permitting such at least one second user to respond to such stored at least one survey). Preferably, surveys can be stored in voice messaging system 115 (at least embodying herein storing such at least one survey). Preferably, voice messaging system 115 allows user 101 to build menus with first submenus, and such first submenus can have subordinate second submenus. Preferably, user 101 breaks up a listing of questions into different sets or groups which allows someone to have easy access to different sections. Preferably, voice messaging system 115 keeps track of the current location within a survey in case a user is interrupted in the middle and needs to call again and go back to the last question in the survey. Preferably, voice messaging system 115 provides user 101 with a summary of the survey responses by playing the question and answer options in sequence. Preferably, the results of the survey are accessible through customizable reports which can be viewed by user 109 via computer. Preferably, by navigating through the menu as a user, a system administrator can re-record survey prompts by entering a special code sequence.

For example, voice messaging system 115 could be used to create a nursing evaluation survey. In such a survey, there could be questions such as: “The information provided by the help desk was adequate,” and “The instructions provided by the care provider were clear.” Example survey responses for such questions could be: “strongly agree, agree, disagree, strongly disagree, or not applicable,” or other responses customized by the survey author, etc.

Preferably, voice messaging system 115 has a report-template feature that permits user 101 to optionally create templates (at least embodying herein permitting such at least one first user to create at least one report template to facilitate inserting at least one pre-recorded header into such at least one medical report) which can be used to insert pre-recorded subject headings (headers) into voice reports (at least embodying herein allowing such at least one first user to insert at least one pre-recorded header associated with at least one section of such at least one medical report). Preferably, report-template feature allows user 101 to create templates which guide and prompt user 101 during the recording and listening of a report. Preferably, while recording a voice report, user 101 may optionally insert a pre-recorded header (by pressing a key on the phone key-pad) that will precede a section of the voice report. Preferably, voice messaging system 115 includes a listing of pre-recorded headers, including SBAR (Situation-Background-Assessment-Recommendation) items, for different scenarios. Preferably, when utilizing the template feature, instead of talking all the way through the voice report, user 101 inserts headers so the person that listens to the report will hear the topic of each section of the recording.

Preferably, user 109 can access voice messaging system 115 to retrieve data, and messages from storage in voice message database 120 via computer network, as shown.

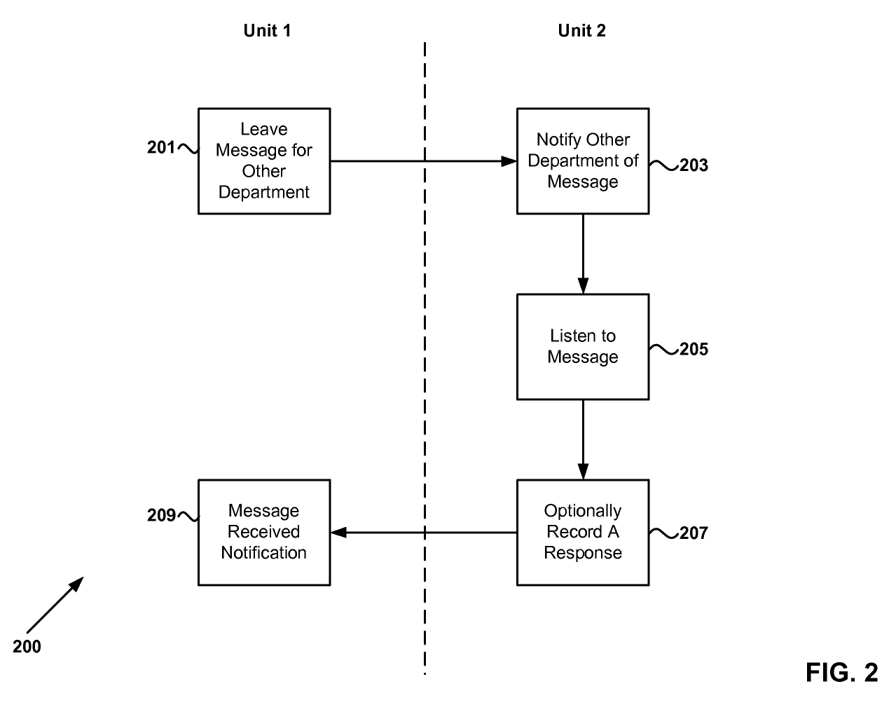

FIG. 2 shows show a simplified diagram of an automatic voice messaging notification and receipt method 200 according to a preferred embodiment of the present invention. Preferably, a first user in a first department leaves a first message for a second user in a second department as indicated by step 201. Preferably, the second user in the second department is notified of the first message, as indicated by step 203. Preferably, the second user in the second department listens to the first message as indicated by step 205. Preferably, after the second user listens to the first message, the second user has the option of responding to the first user by recording a second message (response) as indicated by step 207. Preferably, after the second user listens to the first message the first user is notified that the second user has listened to the first message as indicated by step 209. Preferably, the first user is also notified whether the second user has recorded a response (second message). Preferably, if the second user has recorded a second message, the first user can listen to the second message.

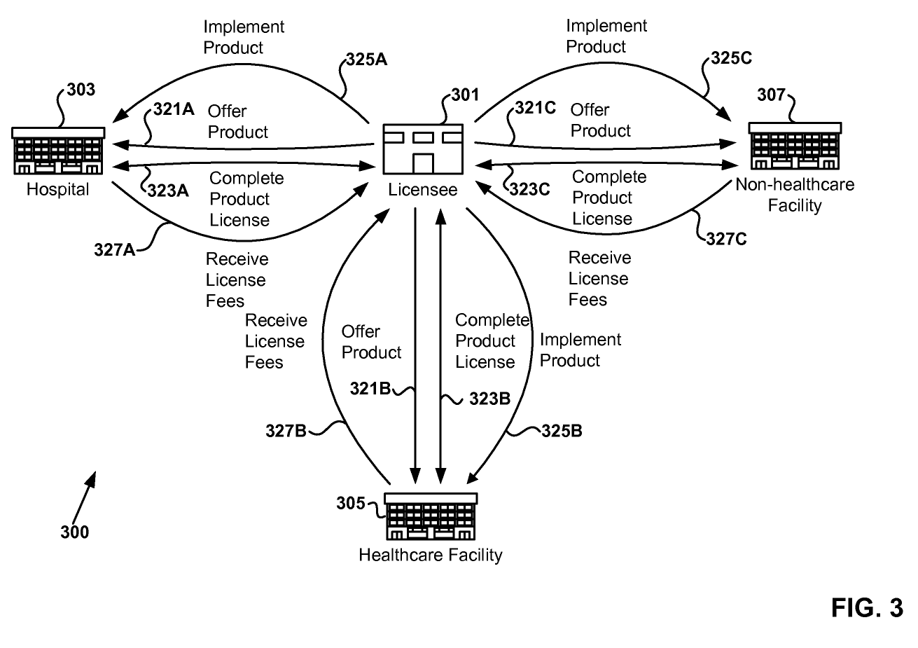

FIG. 3 shows a simplified diagram of a voice messaging system business method 300 according to a preferred embodiment of the present invention. Preferably, Licensee 301 offers voice messaging product to hospital 303 as indicated by step 321A. Preferably, Licensee 301 offers product license to hospital 303 as indicated by step 323A in exchange for receiving licensing fees as indicated by step 327A. Preferably, Licensee 301 assists in implementing product for hospital 303 as indicated by step 325A. Preferably, Licensee 301 offers voice messaging product to healthcare facility 305 as indicated by step 321B. Preferably, Licensee 301 offers product license to healthcare facility 305 as indicated by step 323B in exchange for receiving licensing fees as indicated by step 327B. Preferably, Licensee 301 assists in implementing product for healthcare facility 305 as indicated by step 325B. Preferably, Licensee 301 offers voice messaging product to non-healthcare facility 307 (such as, for example, business facility, insurance company, law enforcement facility, etc.) as indicated by step 321C. Preferably, Licensee 301 offers product license to non-healthcare facility 307 as indicated by step 323C in exchange for receiving licensing fees as indicated by step 327C. Preferably, Licensee 301 assists in implementing product for non-healthcare facility 307 as indicated by step 325C.

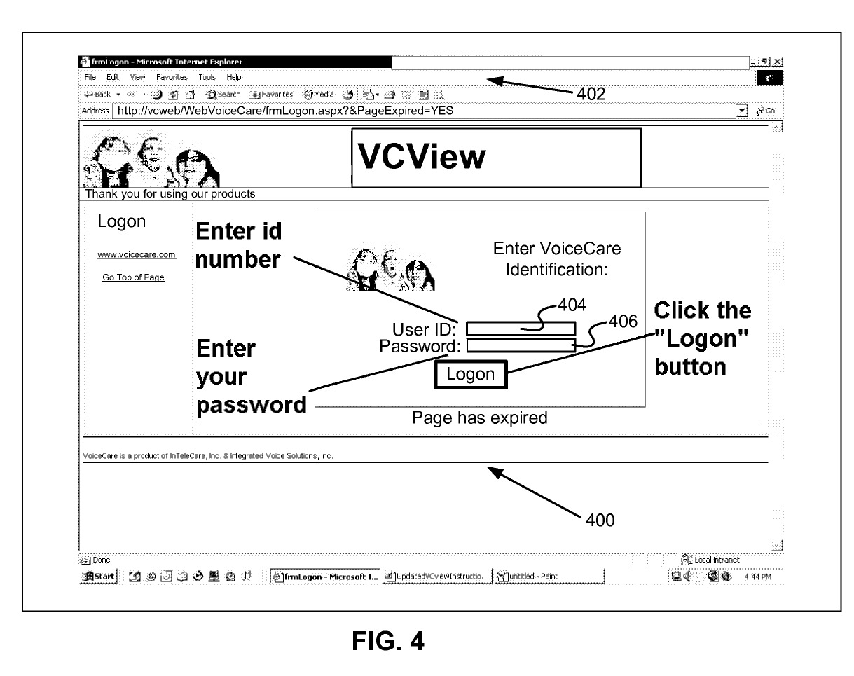

Reference is now made to FIG. 1 and FIG. 4. Preferably, a user utilizes a web browser 402 (FIG. 4) to access voice messaging system website 400 of voice messaging system 115 (FIG. 1) via computer network (at least embodying herein permitting such at least one first user to access such at least one audio messaging database using at least one visual computer display). Preferably users logon to voice messaging system 115 by submitting authorization information. Preferably, authorization information comprises user ID 404 and password 406, as shown in FIG. 4.

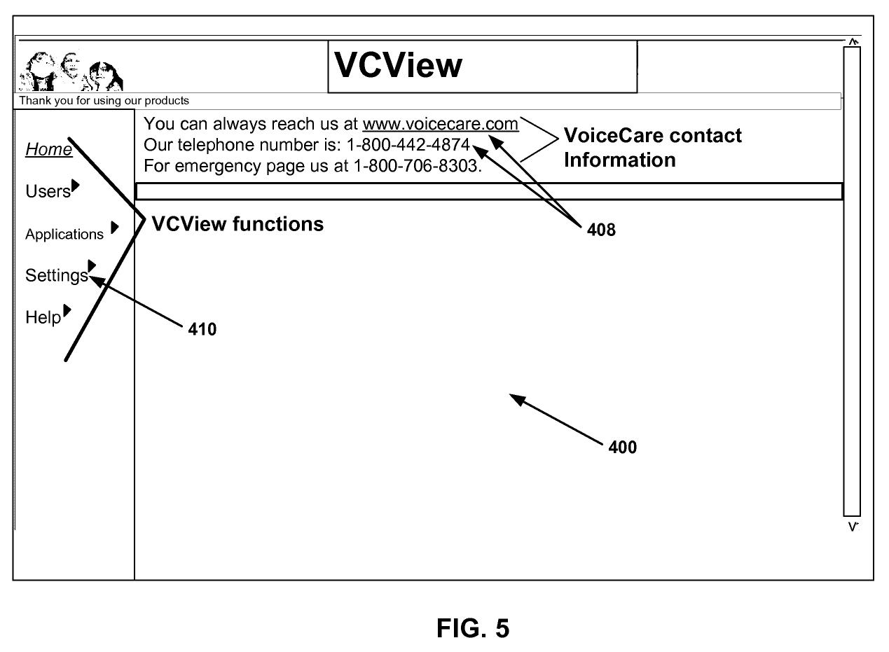

Preferably, content for computer interface with voice messaging system 115 comprises contact information 408 (FIG. 5) for contacting voice messaging system provider (such as, for example, web address, mailing address, business and after-hour contact phone numbers, etc.). Preferably, voice messaging system website 400 comprises menu driven functions 410, as shown.

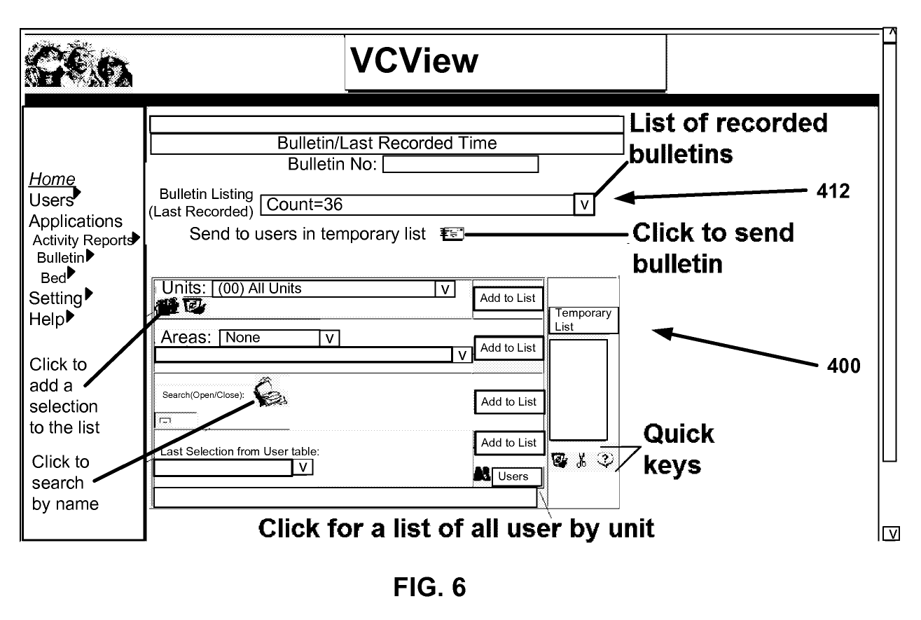

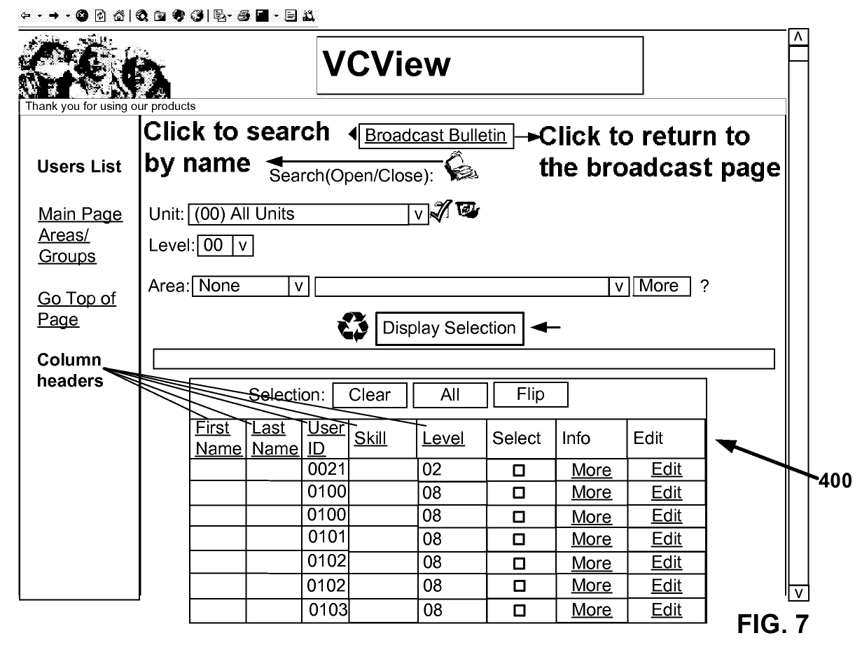

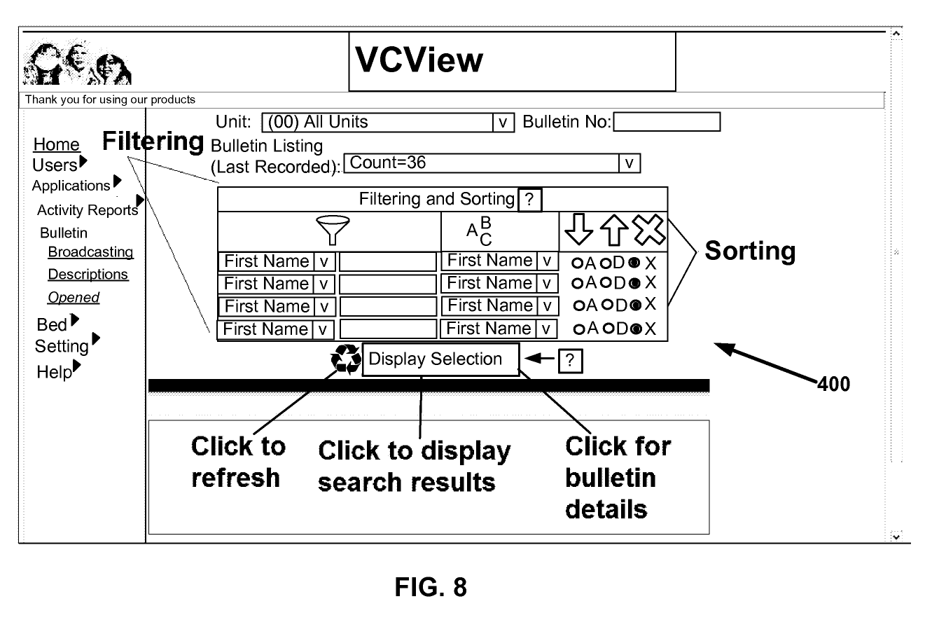

FIG. 6 through FIG. 8 show web page interfaces, according to a preferred embodiment of the present invention, which facilitate sending bulletin messages to multiple users. Preferably, voice messaging system 115 allows user 101 (FIG. 1) to send bulletin messages to multiple recipients simultaneously. Preferably, voice messaging system 115 allows user 101 to send and receive internal voice mail messages for all staff, including those who do not have a private phone extension. Preferably, messages also can be sent via pager. Preferably, a Bulletin Board option allows managers to send group messages to all staff on their unit, or to other units (at least embodying herein permitting such at least one first user to create at least one group message). Preferably, voice messaging system 115 allows user 101 to create and edit recipient lists (of users that will receive a bulletin) from a database of users within voice messaging system 115 (at least embodying herein wherein such at least one group message may be delivered to at least one set of such users of such at least one plurality of users). Preferably, computer user 109 can retrieve bulletins from voice messaging system 115. Preferably, voice messaging system 115 provides user 109 with search capabilities which allow user 109 to find specific bulletins. Preferably, voice messaging system 115 also allows user 109 to select bulletins from a chronologically ordered list of bulletins. Preferably, user 101 selects a bulletin to broadcast by selecting a bulletin from a list of bulletins 412 (FIG. 6). FIG. 7 shows a users list page, according to a preferred embodiment of the present invention, which helps facilitate selecting users to which bulletins can be distributed. FIG. 8 shows a filtering/sorting web page, according to a preferred embodiment of the present invention, which helps facilitate filtering and sorting users to which bulletins can be distributed.

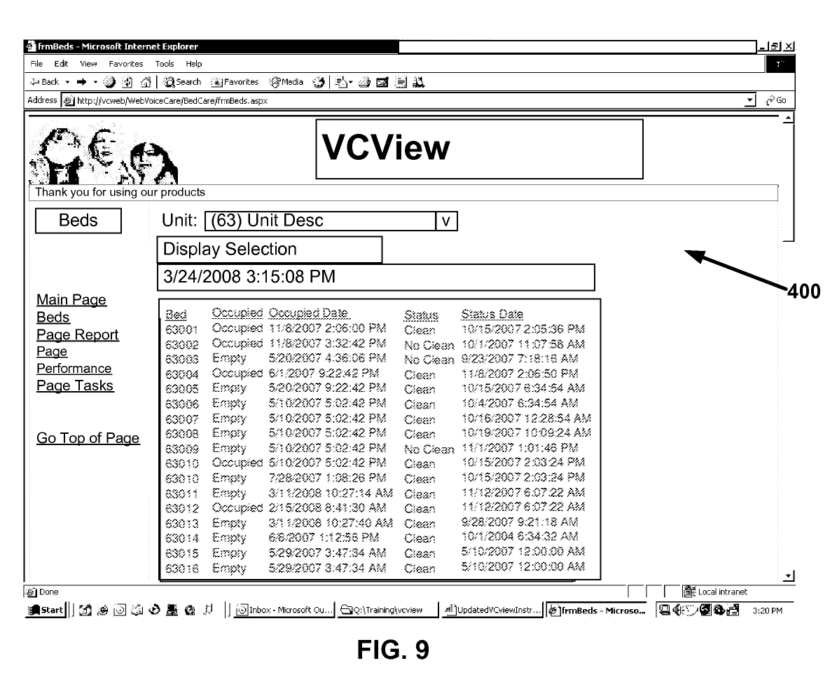

FIG. 9 shows a bed status web page, according to a preferred embodiment of the present invention, which helps facilitate identifying the status of hospital beds (such as, for example, to determine whether a hospital bed is empty or occupied, clean or not clean, how long a bed has been occupied, etc.), as shown. Preferably, bed status reports can be used to track the readiness status of hospital beds (at least embodying herein generating at least one bed status report from such at least one bed inventory; and at least embodying herein wherein such at least one bed status report comprises at least one bed readiness status). Preferably, voice messaging system 115 allows priority status to be assigned to beds, as needed.

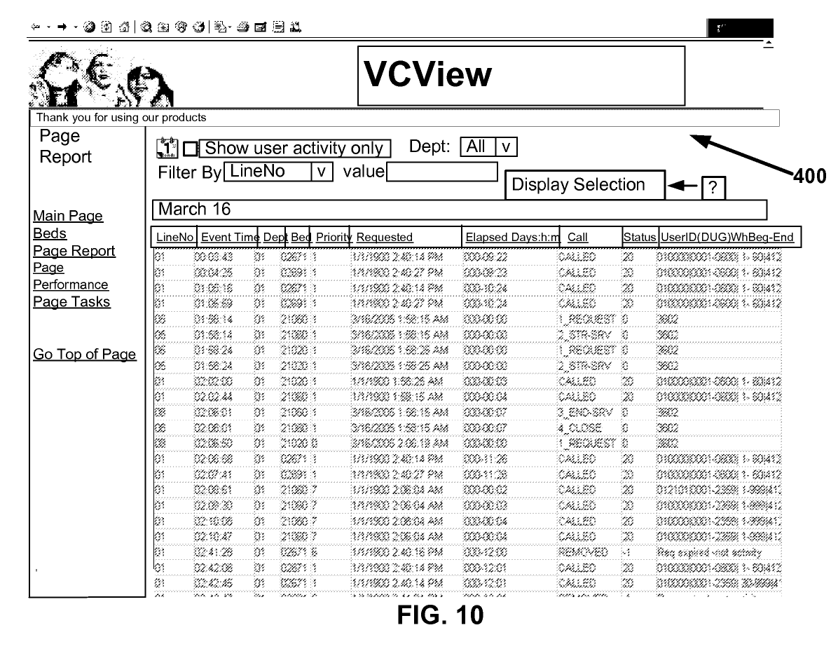

FIG. 10 shows a page report web page, according to a preferred embodiment of the present invention, which gives a compiled table of the paging system data within the facility (such as, for example, Request—lists the time the request was submitted, Str-ser—reports the time that it takes to start a job from the request time, End-ser—reports the time that it takes from the request time to finish the job completely,

Close—reports the time that was spent performing the job, etc.), as shown. Preferably, voice messaging system website 400 provides interfaces for viewing statistical reports of data within voice messaging system 115 (such as, for example, utilization of voice messaging system 115, current and historical status, performance and efficiency metrics, etc.).

Preferably, voice messaging system 115 has a patient reporting feature that permits user 101 to to record and retrieve reports in hospitals, home care agencies, long-term care facilities and outpatient clinics. Preferably, reports can be accessed individually or in sequence, or in a charge nurse format. Preferably, reports transfer with the patient. Preferably, an addendum feature allows new information to be attached directly to an existing report.

Preferably, voice messaging system 115 allows multi-disciplinary communication team reports. For example, these team reports can be utilized by therapists, case workers, dieticians, doctors, and members of other disciplines, etc., to leave patient information for nurses. Preferably, as with nursing addenda, these team reports are added to the end of shift reports, and they can be sent, as well, by page to the nursing station.

Preferably, old messages and data within voice messaging system 115 are archived for a specified period of time, so they may be retrieved later.

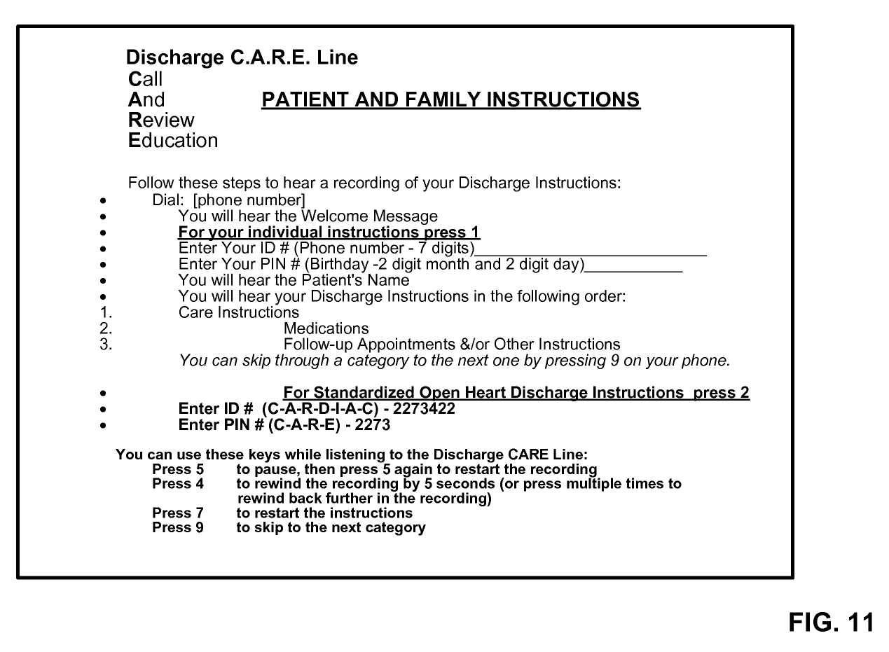

Preferably, voice messaging system 115 incorporates several types of user help. Preferably, users are guided by voice announcements of all menus and sub-menus, voice echo of information entered by users, voice prompts, help cards, training videos, user guides, periodic e-newsletters and updates, telephone help desk, and access to emergency help desk by pager. FIG. 11 shows a sample instruction card preferably provided to patients upon discharge. As shown, instructions for dialing into the voice messaging system 115, entering an ID number and PIN number, a description of the menu structure and options are provided.

Although applicant has described applicant's preferred embodiments of this invention, it will be understood that the broadest scope of this invention includes modifications such as diverse shapes, sizes, and materials. Such scope is limited only by the below claims as read in connection with the above specification.

Further, many other advantages of applicant's invention will be apparent to those skilled in the art from the above descriptions and the below claims.

What is claimed is:

1) A computer-based messaging system, relating to managing audio message communication between at least one first user and at least one second user of at least one plurality of users comprising the steps of:
a) permitting, by such at least one first user, recording at least one first audio message;
b) storing such at least one first audio message in at least one audio messaging database;
c) sending, to such at least one second user, at least one first notification that such at least one first audio message has been recorded;
d) permitting such at least one second user to play back such stored at least one first audio message; and
e) sending, to such at least one first user, at least one second notification that such stored at least one first audio message has been played back.

2) The computer-based messaging system according to claim 1 further comprising the steps of:
a) permitting such at least one second user to record at least one second audio message;
b) storing such at least one second audio message in said at least one audio messaging database;
c) wherein such at least one second notification comprises at least one indication that such at least one second audio message has been recorded; and
d) permitting such at least one first user to play back such stored at least one second audio message.

3) The computer-based messaging system according to claim 2 further comprising the step of permitting such at least one second user to optionally delay sending such at least one second notification.

4) The computer-based messaging system according to claim 1 wherein such at least one second notification message comprises information identifying such at least one second user.

5) The computer-based messaging system according to claim 1 further comprising the step of permitting such at least one first user to optionally delay sending such at least one first notification.

6) The computer-based messaging system according to claim 1 further comprising the steps of:
a) permitting capture of at least one name relating to at least one patient;
b) storing such at least one name relating to such at least one patient in at least one audio messaging database;
c) permitting capture of at least one medical history relating to such at least one patient;
d) storing such at least one medical history relating to such at least one first patient in at least one audio messaging database;
e) permitting capture of at least one medical report relating to such at least one patient; and
f) storing such at least one medical report relating to such at least one patient in at least one audio messaging database.

7) The computer-based messaging system according to claim 6 further comprising the step of permitting capture of at least one care reminder which can be accessed by such at least one patient.

8) The computer-based messaging system according to claim 6 further comprising the step of allowing such at least one first user to insert at least one pre-recorded header associated with at least one section of such at least one medical report.

9) The computer-based messaging system according to claim 6 further comprising the step of permitting such at least one first user to create at least one report template to facilitate inserting at least one pre-recorded header into such at least one medical report.

10) The computer-based messaging system according to claim 1 further comprising the steps of:
a) permitting such at least one first user to create at least one survey;
b) storing such at least one survey; and
c) permitting such at least one second user to respond to such stored at least one survey.

11) The computer-based messaging system according to claim 1 wherein such at least one first audio message is recorded using at least one telephone.

12) The computer-based messaging system according to claim 1 wherein such at least one first notification is sent via at least one pager.

13) The computer-based messaging system according to claim 1 wherein such at least one first notification is sent via at least one fax machine.

14) The computer-based messaging system according to claim 1 wherein such at least one first notification is sent via at least one telephone.

15) The computer-based messaging system according to claim 1 wherein such at least one first notification is sent via at least one workstation computer.

16) The computer-based messaging system according to claim 11 wherein such at least one first notification is presented on at least one browser-based display using such at least one workstation computer.

17) The computer-based messaging system according to claim 1 further comprising the steps of:
a) obtaining at least one bed inventory comprising at least one plurality of beds;
b) storing such at least one bed inventory in such at least one audio messaging database; and
c) associating at least one first bed of such plurality of beds with such at least one patient.

18) The computer-based messaging system according to claim 13 further comprising the steps of:
a) permitting recording at least one transfer of such at least one patient from such at least one first bed to at least one second bed;
b) storing such at least one transfer of such at least one patient from such at least one first bed to at least one second bed in such at least one audio messaging database; and
c) permitting, by such at least one first user, querying such at least one audio messaging database, using such at least one first bed, to determine such at least one second bed relating to such at least one transfer relating to such at least one patient.

19) The computer-based messaging system according to claim 17 further comprising the step of generating at least one bed status report from such at least one bed inventory.

20) The computer-based messaging system according to claim 19 wherein such at least one bed status report comprises at least one bed readiness status.

21) The computer-based messaging system according to claim 1 further comprising the steps of:
a) permitting recording at least one family message relating to such at least one patient by such at least one first user;
b) storing such at least one family message relating to such at least one patient in such at least one audio messaging database; and
c) permitting at least one family member of such at least one patient to play back such at least one family message relating to such at least one patient.

22) The computer-based messaging system according to claim 1 further comprising the steps of:
a) permitting capture of at least one admission report relating to at least one patient from at least one admitting physician;
b) storing such at least one admission report relating to at least one patient in such at least one audio messaging database;
c) permitting such at least one first user to record at least one medical alert relating to such at least one patient; and
d) storing such at least one medical alert relating to such at least one first patient in such at least one audio messaging database;
e) wherein such at least one medical alert must be played back during play back of such stored at least one first audio message.

23) The computer-based messaging system according to claim 1 further comprising the steps of:
a) permitting such at least one first user to create at least one group message; and
i) wherein such at least one group message may be delivered to at least one set of such users of such at least one plurality of users, and
ii) wherein such at least one group message may be created from such at least one first message;
b) requiring, by each such user of such at least one set of such users, play back of such at least one group message.

24) The computer-based messaging system according to claim 1 further comprising the step of:
a) permitting such at least one first user to access such at least one audio messaging database using at least one visual computer display.

25) The computer-based messaging system according to claim 24 further comprising the step of:
a) permitting such at least one first user to visually display at least one report retrieved from such at least one audio messaging database using at least one visual computer display.

26) The computer-based messaging system according to claim 24 further comprising the step of:
a) permitting such at least one first user to send at least one bulletin message to at least one plurality of recipients using at least one visual computer interface.

27) A computer-based method, relating to providing audio-based electronic messaging between at least one first user and at least one second user, comprising the steps of:
a) offering at least one voice messaging product to at least one hospital;
b) licensing such at least one voice messaging product to such at least one hospital;
c) assisting implementation of such at least one voice messaging product to such at least one hospital;
d) providing access to such at least one hospital of at least one voice message database; and
e) receiving payment from such at least one hospital.

28) A telephonic method for managing patient after-care, comprising the steps of:
a) recording at least one audio message, the at least one audio message including information related to patient after-care;
b) receiving, via a telephone, at least one request to play such at least one audio message;
c) validating the at least one request, to establish that the at least one request is from a discharged patient authorized to receive the at least one audio message; and
d) playing the at least one audio message, via the telephone, only if the at least one request is validated.

29) A telephonic method for providing patient status information, comprising the steps of:
a) recording at least one audio message, the at least one audio message including information related to the status of a patient;
b) receiving, via a telephone, at least one request to play such at least one audio message;
c) validating the at least one request, to establish that the at least one request is from a person eligible to receive confidential health-related information about the patient; and
d) playing the at least one audio message, via the telephone, only if the at least one request is validated.
